(19) United States
(12) Patent Application Publication
(10) Pub. No.: US 2012/0219936 A1
(43) Pub. Date: Aug. 30, 2012

(54) ARTICULATOR

(75) Inventor: Reo FURUKI, Kyoto (JP)

(73) Assignee: TRIMUNT CORPORATION, Nakagyo-ku (JP)

(21) Appl. No.: 13/405,731

(22) Filed: Feb. 27, 2012

(30) Foreign Application Priority Data
Feb. 28, 2011 (JP) 2011-042139

(51) Int. Cl. G09B 23/28

(52) U.S. Cl. 434/264

(57) ABSTRACT

An articulator with which an upper/lower jaw open condition can be held and released easily, thereby improving an efficiency with which dentistry techniques are practiced, includes: a support member having a rod-shaped support shaft body; an upper jaw side connecting member attached to the support shaft body in an appropriate axial direction position; a lower jaw side connecting member connected rotatably to the upper jaw side connecting member; an upper jaw model attached to the upper jaw side connecting member; and a lower jaw model attached to the lower jaw side connecting member, wherein the lower jaw side connecting member includes a stopper that is fitted and latched to the support shaft body when rotated to a predetermined position.

### BACKGROUND OF THE INVENTION

1. Field of the Invention

The present invention relates to an articulator suitable for use in the practice of dentistry techniques and so on.

2. Description of the Related Art

An articulator is used conventionally in the practice of dentistry techniques and so on. In an articulator, upper and lower jaw models provided respectively with dentitions are connected on a rear side via connecting members so that the upper and lower jaw models approach and separate from each other and so that when the upper and lower jaw models are at a maximum closeness, the upper and lower dentitions are occluded (intermeshed). An articulator may take various forms, but during the practice of dentistry techniques in a dental university, a dental hygienist college, or the like, articulators that reproduce actual structures and movements well are employed.

Conventional articulators used in the practice of dentistry techniques are described in U.S. Publication 2008/0220404A1, Japanese Patent Application Publication No. 2010-231167, and so on. A particularly widely used example thereof is shown in FIGS. 15 to 17. An articulator 101 includes, as a basic configuration, a support member 102 having a rod-shaped support shaft body 120, an upper jaw side connecting member 103 attached to the support shaft body 120, a lower jaw side connecting member 104 connected rotatably to the upper jaw side connecting member 103, an upper jaw model 105 attached to the upper jaw side connecting member 103, and a lower jaw model 106 attached to the lower jaw side connecting member 104.

The connection between the upper jaw side connecting member 103 and the lower jaw side connecting member 104 is configured as follows in order to reproduce a jaw joint function. The upper jaw side connecting member 103 is provided with rotation shaft portions 133 extending outward in left-right symmetry (see FIG. 16). The lower jaw side connecting member 104, meanwhile, is provided with shaft hole portions 141a that contact the rotation shaft portions 133. Further, spring members 104A extend between the rotation shaft portions 133 and the lower jaw side connecting member 104 (more specifically, spring hook portions 142 formed on the lower jaw side connecting member 104 to project outward in left-right symmetry), and the shaft hole portions 141a are held in contact with the rotation shaft portions 133 to be capable of rotating by a biasing force of the spring members 104A.

Further, two position fixing members 107, 107′ are attached to the support shaft body 120. When the lower jaw side connecting member 104 is rotated by applying external force thereto such that a gap between upper and lower dentitions 105a, 106a gradually opens, the lower jaw side connecting member 104 comes into contact with the support shaft body 120, and by moving the two position fixing members 107, 107′ in an approaching direction at this time such that the lower jaw side connecting member 104 is sandwiched between the position fixing members 107, 107′, as shown in FIGS. 15 and 16, a resulting upper/lower jaw open condition can be held. An occlusion condition can be checked by moving the two position fixing members 107, 107′ in a separating direction so as to release the held upper/lower jaw open condition, and then rotating the lower jaw connecting member 104 in an opposite direction to that of the above operation such that the upper and lower dentitions 105a, 106a are occluded, as shown in FIG. 17.

In a most typical method of attaching the upper jaw model 105 and the lower jaw model 106 respectively to the upper jaw side connecting member 103 and the lower jaw connecting member 104, circular attachment holes are formed in a model attachment portion 130 forming a part of the upper jaw side connecting member 103 and a model attachment portion 140 forming a part of the lower jaw side connecting member 104, whereupon attachment screws 130A, 130B, 140A, 140B are passed through the circular attachment holes to attach the upper jaw model 105 and the lower jaw model 106 fixedly to the upper jaw side connecting member 103 and the lower jaw connecting member 104, respectively (see FIG. 16).

Incidentally, when tooth excavation or the like is practiced using a hand piece, operations for checking the occlusion condition of the upper jaw model 105 and the lower jaw model 106 or replacing an excavated tooth must be performed for each excavation. It is therefore desirable to improve the efficiency of the practice of dentistry techniques by ensuring that the upper/lower jaw open condition can be held and released easily, and that the upper jaw model 105 or the lower jaw model 106 can be detached in order to replace a tooth and reattached easily.

As described above, however, operations for holding and releasing the upper/lower jaw open condition using the two position fixing members 107, 107′ and detaching and attaching the upper jaw model 105 and the lower jaw model 106 simply using the attachment screws 130A, 130B, 140A, 140B require a considerable amount of time.

### SUMMARY OF THE INVENTION

The present invention has been designed in consideration of these circumstances, and an object thereof is to provide an articulator with which an upper/lower jaw open condition can be held and released easily and an upper jaw model and a lower jaw model can be detached and attached easily, thereby improving an efficiency with which dentistry techniques are practiced.

To achieve this object, an articulator according to a preferred embodiment of the present invention includes: a support member having a rod-shaped support shaft body; an upper jaw side connecting member attached to the support shaft body in an appropriate axial direction position; a lower jaw side connecting member connected rotatably to the upper jaw side connecting member; an upper jaw model attached so as to contact an attachment surface of a model attachment portion of the upper jaw side connecting member; and a lower jaw model attached so as to contact an attachment surface of a model attachment portion of the lower jaw side connecting member, wherein the lower jaw side connecting member includes a stopper that has a penetrating hollow portion and is fitted and latched to the support shaft body when rotated to a predetermined position.

The stopper is preferably made of synthetic resin. Further, the hollow portion of the stopper preferably penetrates in an inclined direction relative to the attachment surface of the model attachment portion of the lower jaw side connecting member. Furthermore, back surface side recessions are preferably formed in the lower jaw side connecting member at a left position and a right position of the stopper.

Two attachment holes are preferably provided in the respective model attachment portions of the upper jaw side connecting member and the lower jaw side connecting member, two female screw portions are preferably provided in positions of the upper jaw model corresponding to the attachment holes in the model attachment portion of the upper jaw side connecting member, two female screw portions are preferably provided in positions of the lower jaw model corresponding to the attachment holes in the model attachment portion of the lower jaw side connecting member, and the upper jaw model is preferably attached to the upper jaw side connecting member and the lower jaw model is preferably attached to the lower jaw side connecting member by respective attachment screws that are passed through the attachment holes and screwed into the female screw portions.

A screw insertion groove extending diagonally upward or downward so as to communicate with one of the attachment holes and a screw insertion groove extending diagonally downward or upward so as to communicate with another of the attachment holes are preferably provided in the upper jaw side connecting member. Alternatively, screw insertion grooves extending either upward or downward in an identical direction so as to communicate with the two attachment holes are provided in the upper jaw side connecting member. Further, two recessed portions are preferably provided in an attachment surface of the upper jaw side connecting member that is contacted by the upper jaw model, two recessed portions are preferably provided in an attachment surface of the upper jaw model that contacts the upper jaw side connecting member, and deviation preventing bodies are preferably provided on respective inner sides of the recessed portions of the upper jaw model.

A screw insertion groove extending diagonally upward or downward so as to communicate with one of the attachment holes and a screw insertion groove extending diagonally downward or upward so as to communicate with another of the attachment holes are preferably provided in the lower jaw side connecting member. Alternatively, screw insertion grooves extending either upward or downward in an identical direction so as to communicate with the two attachment holes are provided in the lower jaw side connecting member.

Further, two recessed portions are preferably provided in an attachment surface of the lower jaw side connecting member that is contacted by the lower jaw model, two recessed portions are preferably provided in an attachment surface of the lower jaw model that contacts the lower jaw side connecting member, and deviation preventing bodies are preferably provided on respective inner sides of the recessed portions of the lower jaw model.

In some cases, a lower portion of the support shaft body of the support member is preferably bent toward the lower jaw side connecting member.

With the articulator according to the present invention, an upper/lower jaw open condition can be held easily by fitting and latching the stopper to the support shaft body, and the hold can be released easily. Therefore, an improvement can be achieved in the efficiency with which dentistry techniques are practiced. Further, by providing the screw insertion grooves, the upper jaw model and lower jaw model can be detached and attached easily, enabling a further improvement in the efficiency with which dentistry techniques are practiced.

### BRIEF DESCRIPTION OF THE DRAWINGS

FIG. 1 is a side view showing an upper/lower jaw open condition of an articulator according to an embodiment of the present invention;

FIG. 2 is a back view showing the upper/lower jaw open condition of the articulator;

FIG. 3 is a side view showing a condition in which upper and lower dentitions of the articulator are occluded;

FIG. 4 is a reduced side view showing an example of a support member of the articulator;

FIG. 5 shows an upper jaw side connecting member of the articulator, wherein FIG. 5A is a plan view and FIG. 5B is a bottom view;

FIG. 6 shows the vicinity of respective attachment surfaces of the upper jaw model and the upper jaw side connecting member of the articulator, wherein FIG. 6A is a front view of a model attachment portion of the upper jaw side connecting member and FIG. 6B is a back view of the upper jaw model;

FIG. 7 shows a lower jaw side connecting member of the articulator, wherein FIG. 7A is a plan view and FIG. 7B is a bottom view;

FIG. 8 shows the vicinity of respective attachment surfaces of the lower jaw model and the lower jaw side connecting member of the articulator, wherein FIG. 8A is a front view of the lower jaw side connecting member, FIG. 8B is a back view of the lower jaw side connecting member, and FIG. 8C is a back view of the lower jaw model;

FIG. 9 is a sectional view showing a deviation preventing body of the articulator and the vicinity thereof, wherein FIG. 9A shows a condition in which the upper jaw model is attached to the upper jaw side connecting member, and FIG. 9B shows a condition in which the lower jaw model is attached to the lower jaw side connecting member;

FIG. 10 is a reduced side view showing an example in which the support member of the articulator is attached to a mannequin head;

FIG. 11 is a reduced side view showing an example of a case in which the support member of FIG. 10 is bent;

FIG. 12 is a reduced side view showing an example in which the upper jaw model of the articulator is attached to the mannequin head;

FIG. 13 is a reduced side view showing an example of a case in which the lower jaw model of the articulator is attached to a base by a base fixing member;

FIG. 14 shows a modified example of a screw insertion groove of the articulator, wherein FIG. 14A is a front view of the model attachment portion of the upper jaw side connecting member and FIG. 14B is a front view of the lower jaw side connecting member;

FIG. 15 is a side view showing an upper/lower jaw open condition of a conventional articulator;

FIG. 16 is a back view showing the upper/lower jaw open condition of the conventional articulator; and

FIG. 17 is a side view showing a condition in which upper and lower dentitions of the conventional articulator are occluded.

### DETAILED DESCRIPTION OF THE PREFERRED EMBODIMENTS

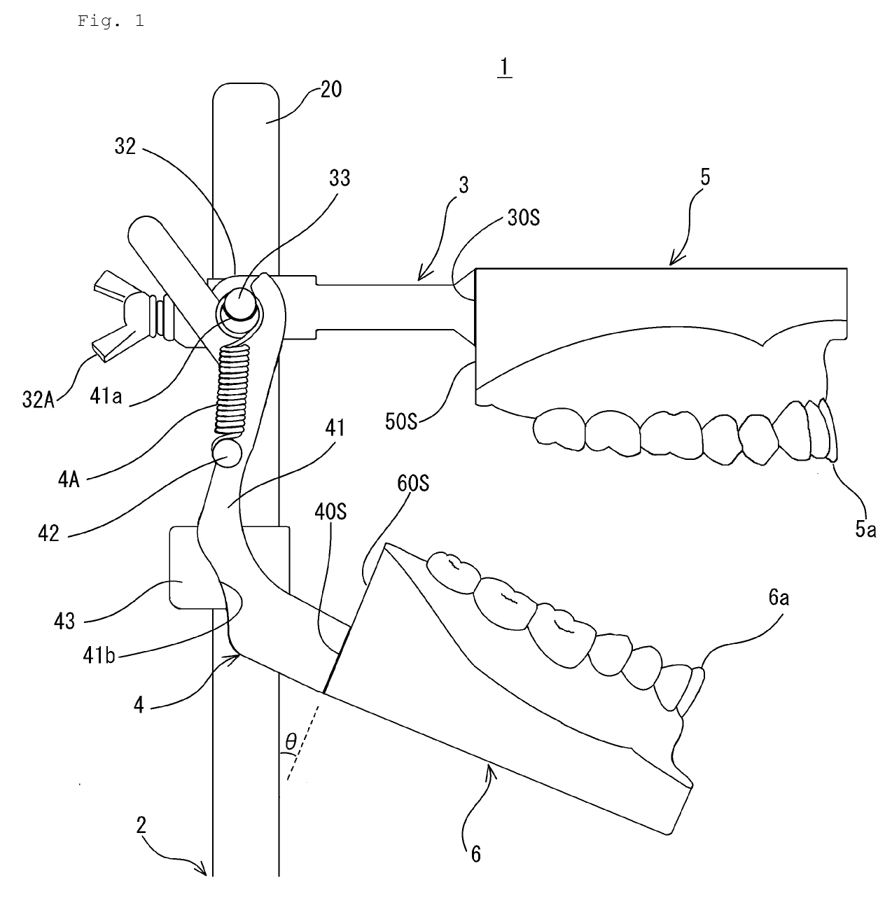

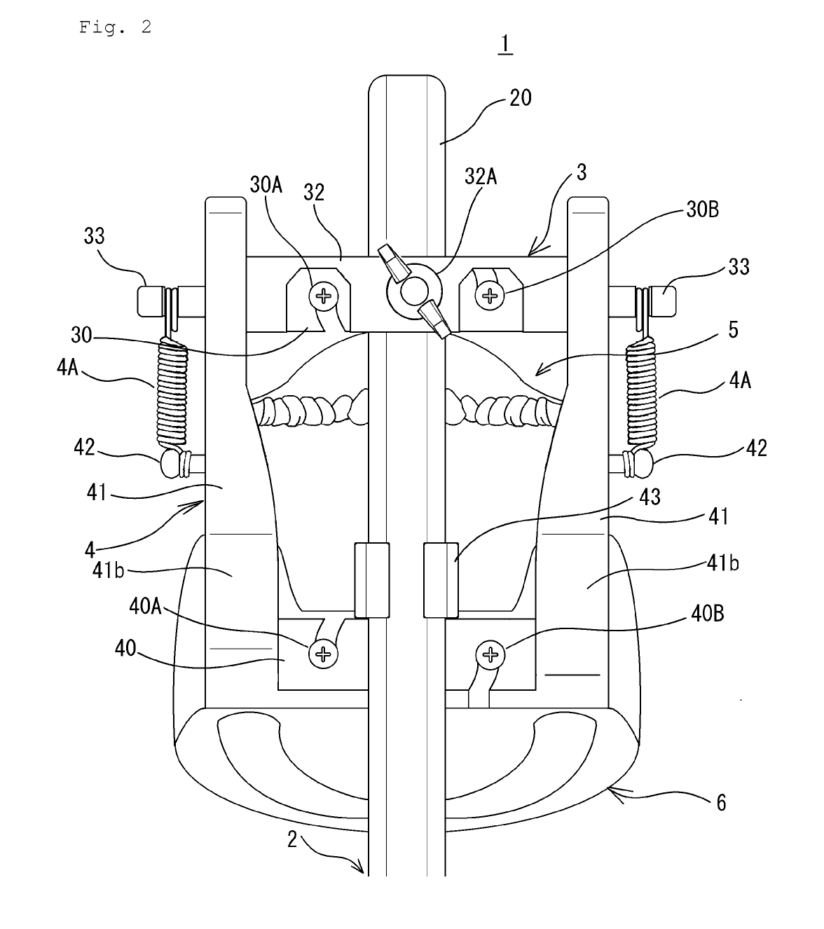

A preferred embodiment of the present invention will be described below. As shown in FIGS. 1 to 3, an articulator 1 according to an embodiment of the present invention includes, as a basic configuration, a support member 2 having a rod-shaped support shaft body 20, an upper jaw side connecting member 3 attached to the support shaft body 20 in an appropriate axial direction position, a lower jaw side connecting member 4 connected rotatably to the upper jaw side connecting member 3, an upper jaw model 5 attached to the upper jaw side connecting member 3, and a lower jaw model 6 attached to the lower jaw side connecting member 4.

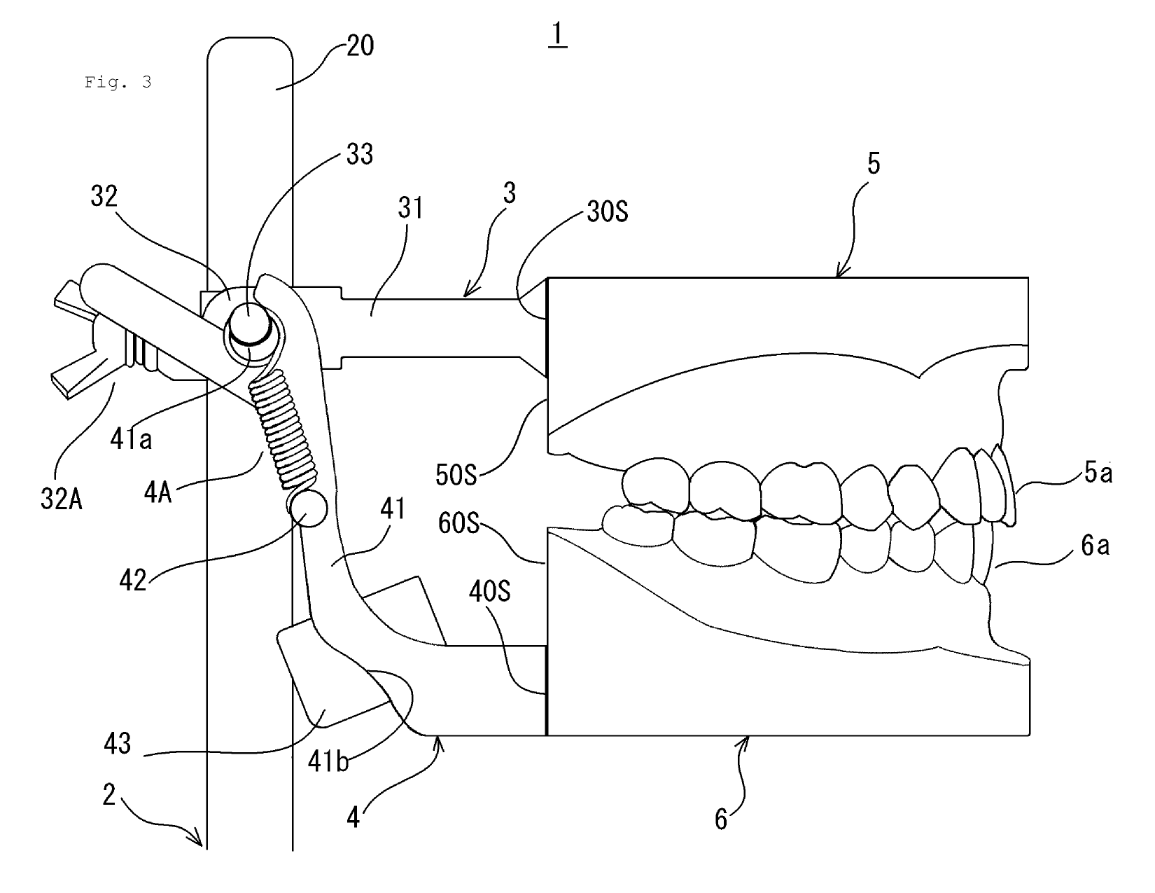

The support member 2 is attached to a base such as a practice treatment table by a base attachment portion 21 such as that shown in FIG. 4, for example. There are no limitations on a structure of the base attachment portion 21. The support shaft body 20 has a flat surface in a part at the back side and a substantially D-shaped cross-section (see FIG. 2). Note that a model (a mannequin head) reproducing another part of a head may also be attached to the support shaft body 20 if required.

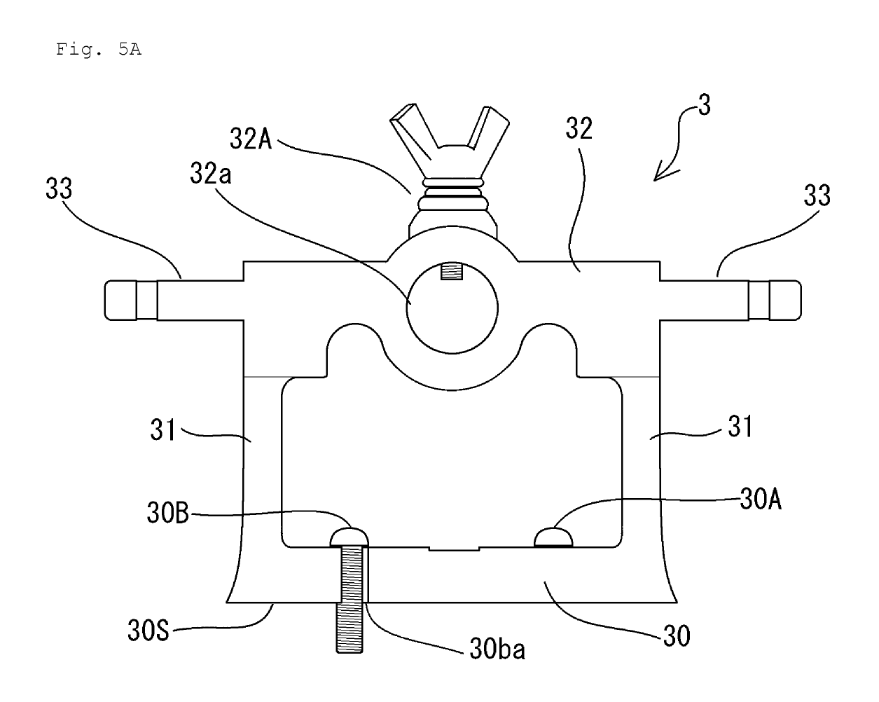

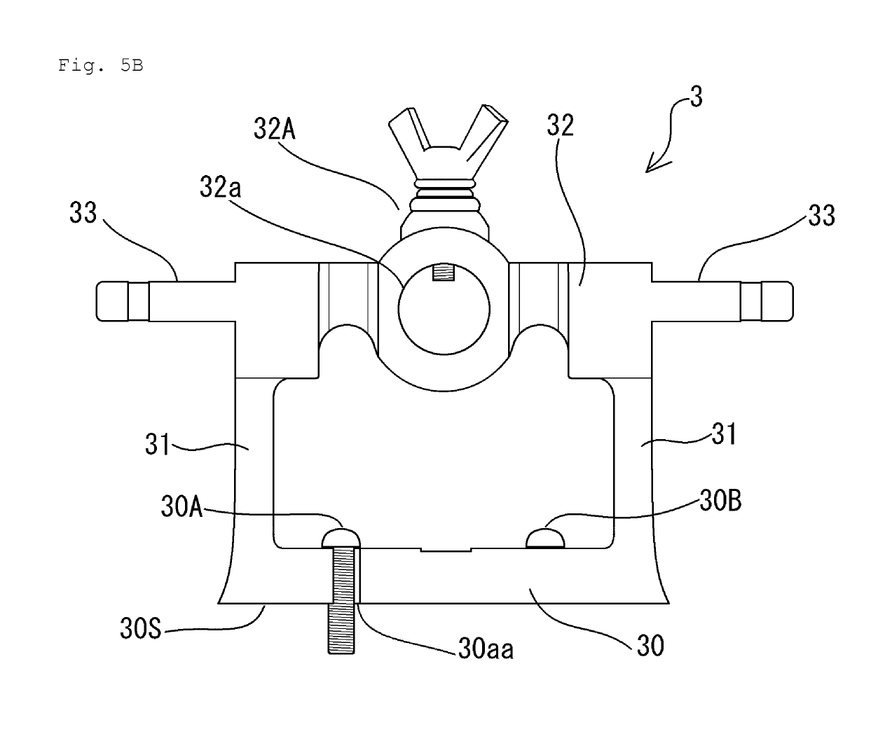

As shown in FIG. 5 and so on, the upper jaw side connecting member 3 includes a model attachment portion 30, side portions 31, a support shaft fixing portion 32, and rotation shaft portions 33.

The upper jaw model 5 is attached to an attachment surface 30S of the model attachment portion 30. The attachment surface 30S is a planar surface having a high degree of flatness, besides the vicinity of attachment holes 30a, 30b and recessed portions 30c, 30d to be described below, from which projecting portions have been removed to ensure that the attachment surface 30S contacts an attachment surface 50S of the upper jaw model 5, to be described below, perfectly.

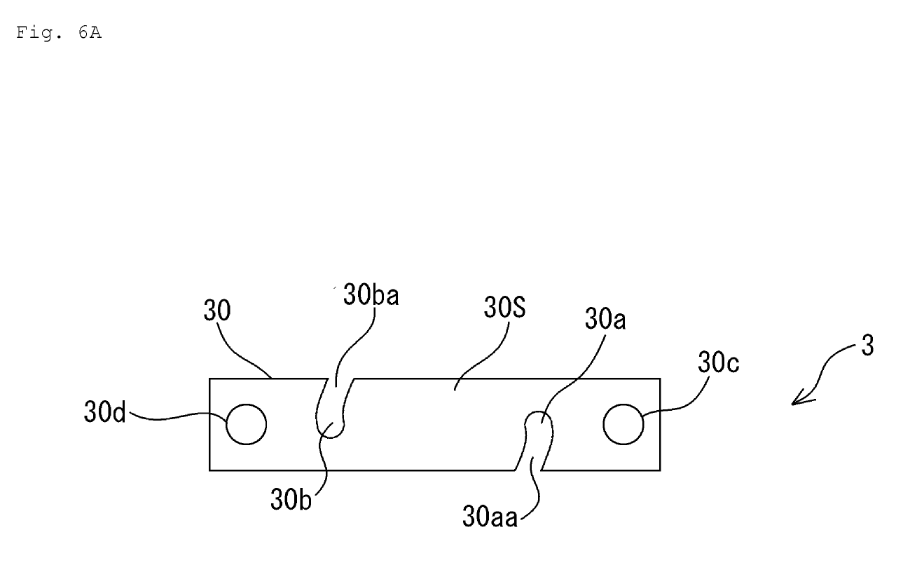

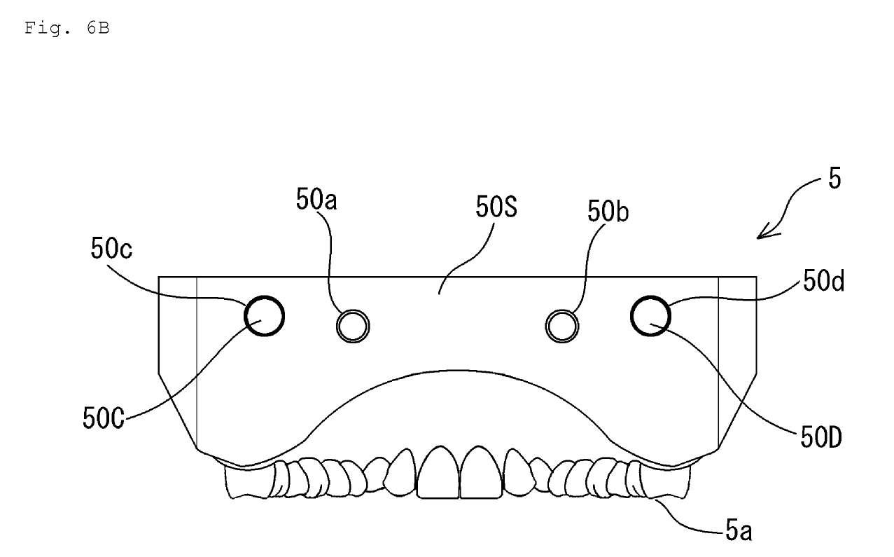

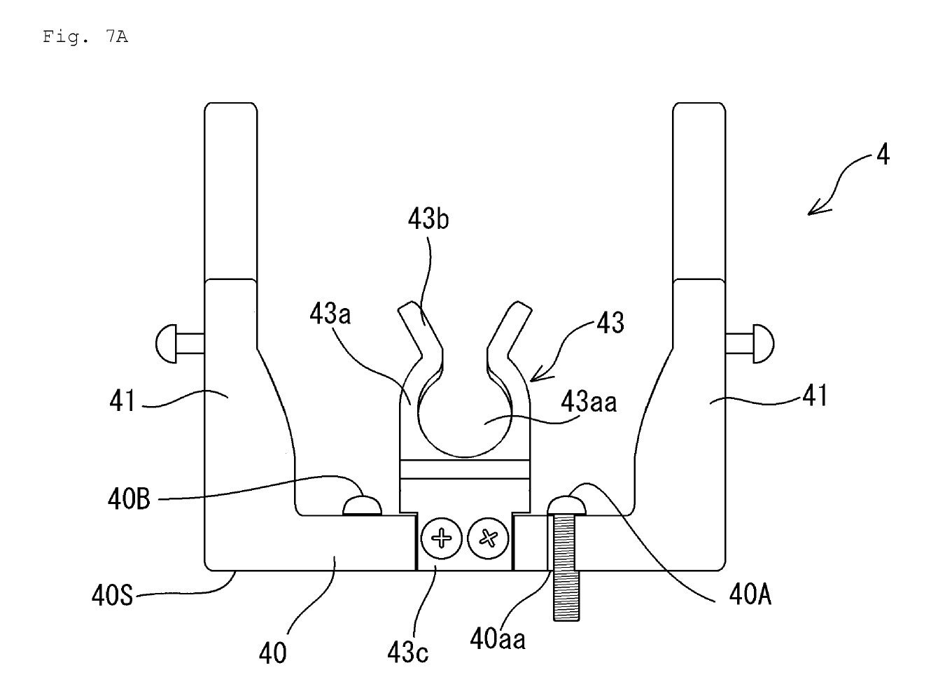

As shown in FIG. 6A, the model attachment portion 30 includes two attachment holes 30a, 30b. The attachment holes 30a, 30b are provided such that a screw insertion groove 30aa extending diagonally downward and a screw insertion groove 30ba extending diagonally upward communicate respectively with the attachment hole 30a and the attachment hole 30b. The screw insertion grooves 30aa, 30ba are formed so that attachment screws 30A, 30B can move when the upper jaw model 5 is rotated in a condition where the attachment screws 30A, 30B are loosely screwed to the upper jaw model 5 in order to screw the upper jaw model 5 fixedly via the attachment holes 30a, 30b, as will be described below. For this purpose, each of the screw insertion grooves 30aa, 30ba is preferably formed as an arc part of a circle having an equidistant dimension from a center thereof as a radius. A configuration in which the screw insertion groove 30aa extends diagonally upward and the screw insertion groove 30ba extends diagonally downward may be employed.

Further, as shown in FIG. 6A, the two recessed portions 30c, 30d are provided in the attachment surface 30S of the model attachment portion 30.

As shown in FIG. 5 and so on, the side portions 31 of the upper jaw side connecting member 3 are parts that connect the model attachment portion 30 to the support shaft fixing portion 32 from the left and right. The support shaft fixing portion 32 is apart for attaching the upper jaw side connecting member 3 to the support shaft body 20, and includes a support shaft hole 32a into which the support shaft body 20 is inserted, and a support shaft fixing screw member 32A that is screwed orthogonally into the support shaft hole 32a. Further, to facilitate an operation for screwing the attachment screws 30A, 30B into the model attachment portion 30 using a screwdriver, parts of the support shaft fixing portion 32 that overlap the attachment screws 30A, 30B from a back side are preferably cut out (see FIG. 2). The rotation shaft portions 33 are parts that the lower jaw side connecting member 4 is connected to and become the axis for the rotation of the lower jaw side connecting member 4, and are provided to project to the left and right of the support shaft fixing portion 32 in an orthogonal direction to the support shaft hole 32a and the support shaft fixing screw member 32A. Each of the rotation shaft portions 33 has a small diameter portion formed with a slightly smaller diameter near the middle in an axial direction thereof.

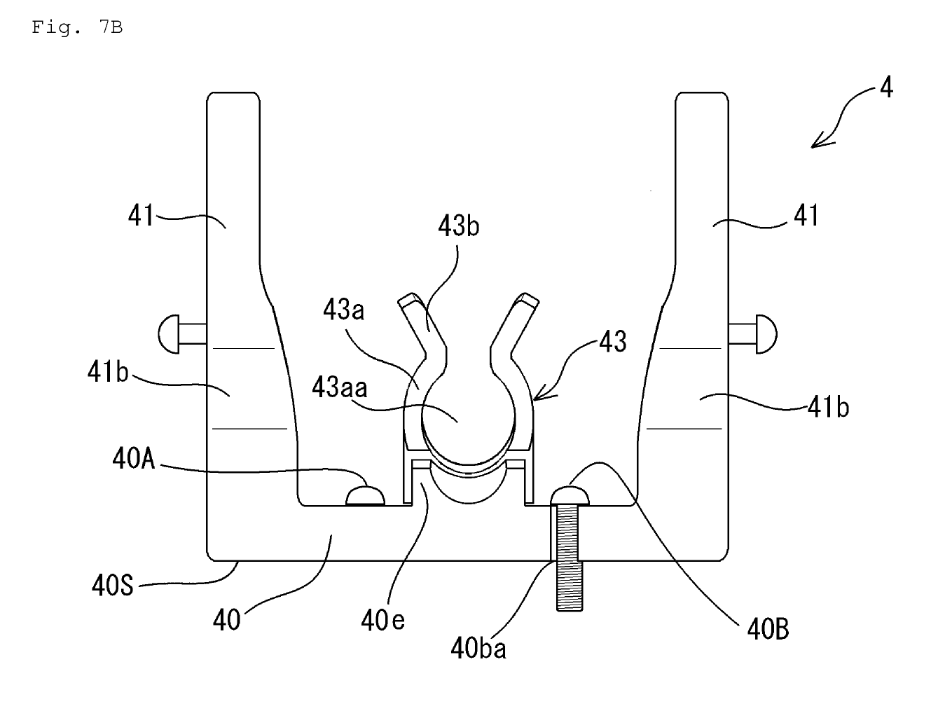

As shown in FIG. 7 and so on, the lower jaw side connecting member 4 includes a model attachment portion 40, rotary side portions 41, and a stopper 43.

The lower jaw model 6 is attached to an attachment surface 40S of the model attachment portion 40. The attachment surface 40S is a planar surface having a high degree of flatness, besides the vicinity of attachment holes 40a, 40b and recessed portions 40c, 40d to be described below, from which projecting portions have been removed to ensure that the attachment surface 40S contacts an attachment surface 60S of the lower jaw model 6, to be described below, perfectly.

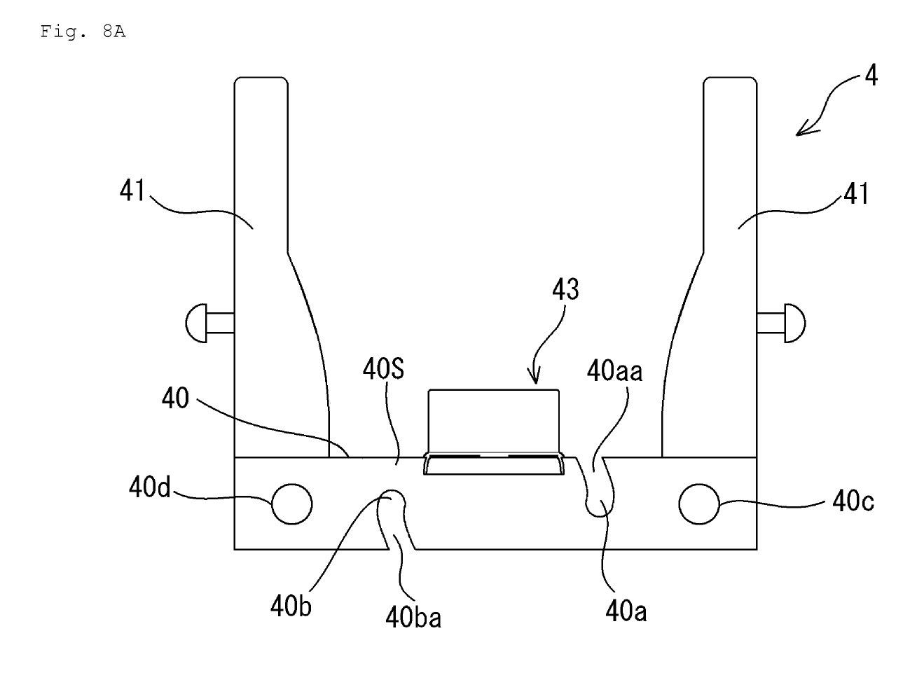

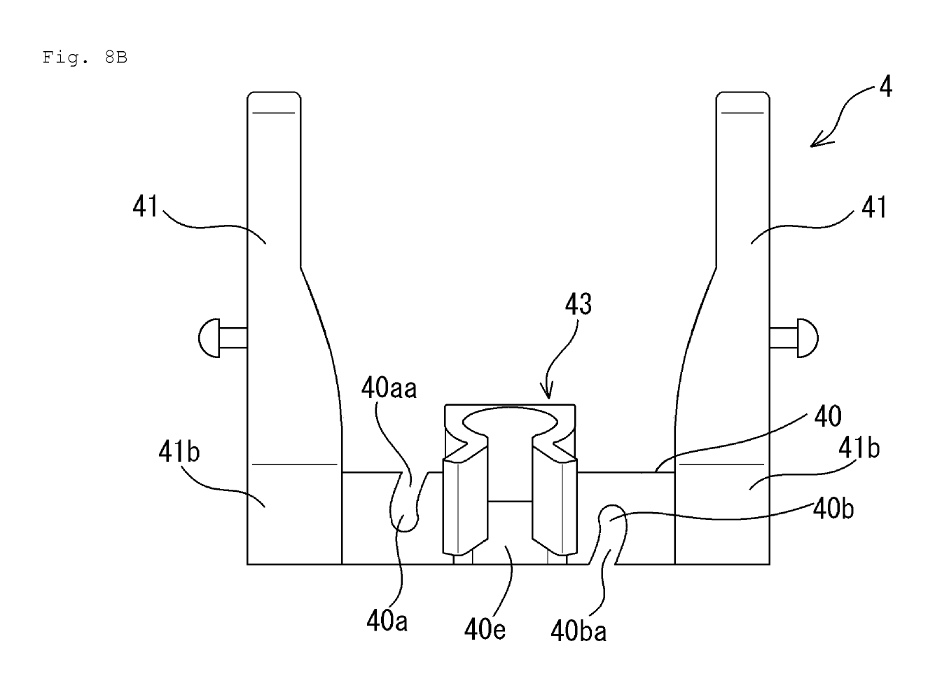

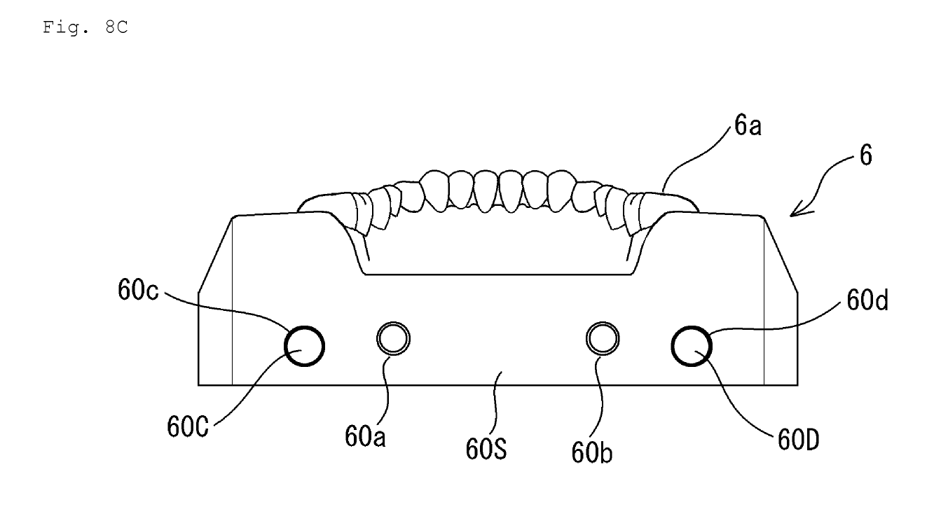

As shown in FIGS. 8A and 8B, the model attachment portion 40 includes the two attachment holes 40a, 40b. The attachment holes 40a, 40b are provided such that a screw insertion groove 40aa extending diagonally upward and a screw insertion groove 40ba extending diagonally downward communicate respectively with the attachment hole 40a and the attachment hole 40b. The screw insertion grooves 40aa, 40ba are formed so that attachment screws 40A, 40B can move when the lower jaw model 6 is rotated in a condition where the attachment screws 40A, 40B are loosely screwed to the lower jaw model 6 in order to screw the lower jaw model 6 fixedly via the attachment holes 40a, 40b, as will be described below. For this purpose, each of the screw insertion grooves 40aa, 40ba is preferably formed as an arc part of a circle having an equidistant dimension from a center thereof as a radius. A configuration in which the screw insertion groove 40aa extends diagonally downward and the screw insertion groove 40ba extends diagonally upward may be employed.

As shown in FIG. 8A, the two recessed portions 40c, 40d are provided in the attachment surface 40S of the model attachment portion 40.

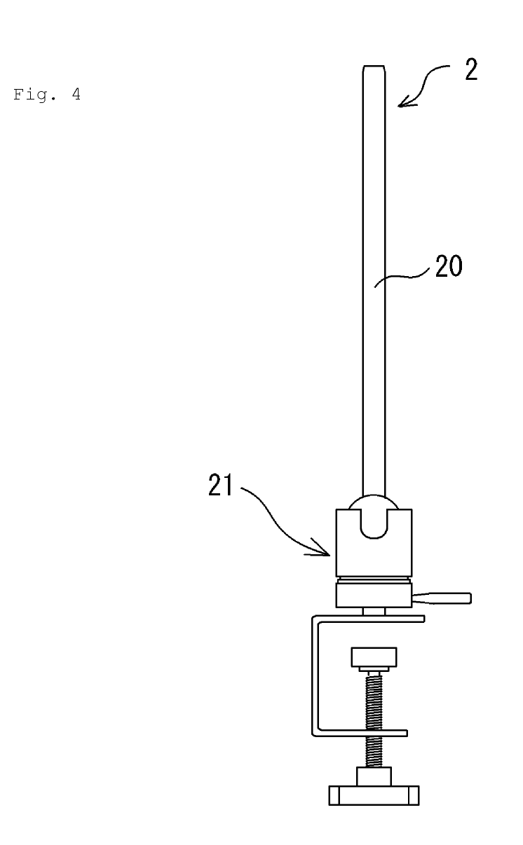

The rotary side portions 41 of the lower jaw side connecting member 4 extend toward the rotation shaft portions 33 of the upper jaw side connecting member 3 from left and right connecting places connected to the model attachment portion 40 (see FIGS. 1 and 3) by gently varying an angle and changing an angle approximating a right angle. Shaft hole portions 41a that contact the rotation shaft portions 33 of the upper jaw side connecting member 3 rotatably are provided in the vicinity of respective tip end portions of the rotary side portions 41 (see FIGS. 1 and 3). The shaft hole portions 41a take a partially open substantially semicircular shape. Further, coil-shaped spring members 4A extend between spring hook portions 42 projecting from the vicinity of an intermediate part of the rotary side portions 41 and the small diameter portions of the rotation shaft portions 33 such that the shaft hole portions 41a are maintained in rotatable contact with the rotation shaft portions 33. Furthermore, back surface side indentations 41b are preferably formed in the rotary side portions 41 at the left position and the right position of the stopper 43 (overlapping positions to the stopper 43 according to the side view) so that when the stopper 43 is detached from the support shaft body 20 in order to release a hold, as will be described below, force can be applied thereto easily using a finger (see FIGS. 1 and 3).

The stopper 43 is used to latch the lower jaw side connecting member 4 to the support shaft body 20, and as shown in FIGS. 7A and 7B, includes a fitting latch portion 43a having a penetrating hollow portion 43aa, wherein a part (approximately one quarter of a circumference, for example) of a side wall of the hollow portion 43aa is cut out, a shaft body insertion portion 43b that extends outward from either side of the cutout while slightly widening, and a fixed portion 43c fixed to a left-right direction central part of the model attachment portion 40. A diameter of the hollow portion 43aa is identical to or slightly smaller than a diameter of the support shaft body 20, and a cutout width of the side wall of the hollow portion 43aa is smaller than the diameter of the support shaft body 20. A penetration direction of the hollow portion 43aa substantially matches the axial direction of the support shaft body 20 when the stopper 43 is fitted and latched to the support shaft body 20 in an upper/lower jaw open condition to be described below (see FIG. 1), or in other words an inclined direction (by an incline angle θ of approximately 25 degrees, for example) relative to the attachment surface 40S of the model attachment portion 40 (see FIG. 1). The stopper 43 is preferably made of a synthetic resin (polyacetal resin or the like, for example) that exhibits an appropriate degree of elasticity and sufficient durability to enable the shaft body insertion portion 43b to be pushed open by the support shaft body 2 so that the support shaft body 2 is fitted and latched to the fitting latch portion 43a, and to withstand tooth excavation practice and the like using a hand piece. Note that the fixed portion 43c of the stopper 43 is fixed by a fixing screw, and to facilitate fixing, a projecting part 40e is provided in a corresponding part of the model attachment portion 40.

As shown in FIGS. 1 and 3, the upper jaw model 5 has the upper side dentition 5a below and includes the attachment surface 50S. The attachment surface 50S serves as an end surface which extends in an identical direction to a tooth implantation direction and contacts the attachment surface 30S of the model attachment portion 30 of the upper jaw side connecting member 3. The attachment surface 50S is a planar surface having a high degree of flatness, besides female screw portions 50a, 50b and recessed portions 50c, 50d to be described below, from which projecting portions have been removed to ensure that the attachment surface 50S contacts the attachment surface 30S of the upper jaw side connecting member 3 perfectly. As shown in FIG. 6B, the two female screw portions 50a, 50b are provided in positions of the attachment surface 50S corresponding to the attachment holes 30a, 30b in the upper jaw side connecting member 3. Hence, by passing the attachment screws 30A, 30B through the attachment holes 30a, 30b and screwing the attachment screws 30A, 30B into the female screw portions 50a, 50b, the upper jaw model 5 is attached to the upper jaw side connecting member 3.

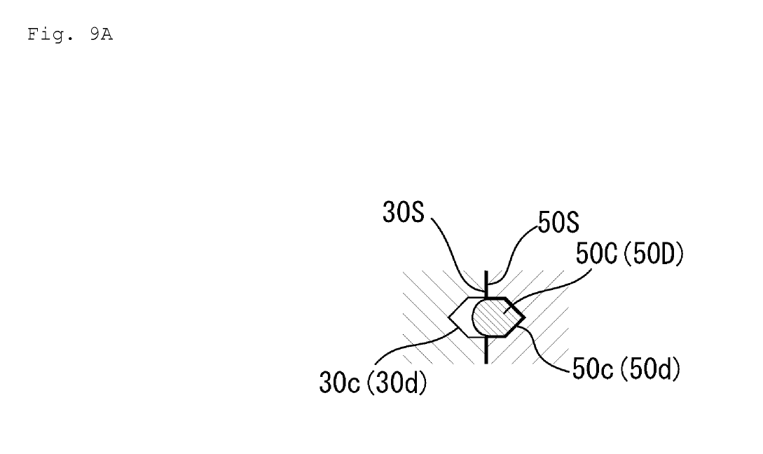

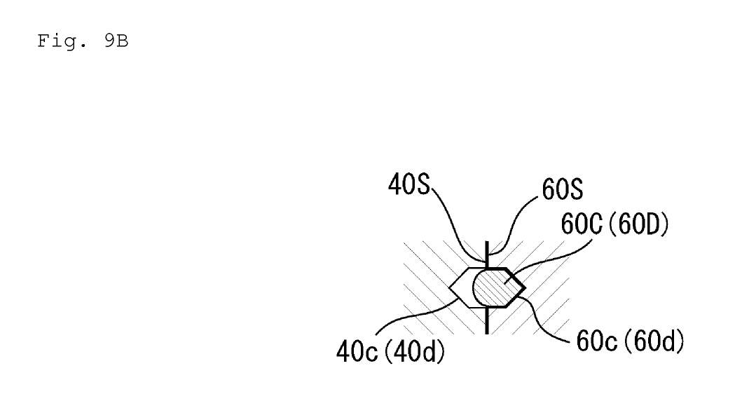

The two recessed portions 50c, 50d are provided in the attachment surface 50S of the upper jaw model 5, and deviation preventing bodies 50C, 50D are provided on respective inner sides of the recessed portions 50c, 50d. The recessed portions 50c, 50d have an equal size to the aforesaid recessed portions 30c, 30d of the upper jaw side connecting member 3, and the deviation preventing bodies 50C, 50D project beyond the attachment surface 50S (see FIG. 9A). More specifically, for easy handling, the deviation preventing bodies 50C, 50D are preferably made of synthetic resin that is injected into the recessed portions 50c, 50d and then hardened. In certain cases, pre-hardened synthetic resin, natural resin, metal, or the like may be fitted into the recessed portions 50c, 50d as the deviation preventing bodies 50C, 50D. As shown in FIG. 9A, when the upper jaw model 5 is attached to the upper jaw side connecting member 3, the deviation preventing bodies 50C, 50D are fitted into the recessed portions 30c, 30d in the upper jaw side connecting member 3, thereby preventing positional deviation.

As shown in FIGS. 1 and 3, the lower jaw model 6 has the lower side dentition 6a above and includes the attachment surface 60S. The attachment surface 60S serves as an end surface which extends in an identical direction to the tooth implantation direction and contacts the attachment surface 40S of the model attachment portion 40 of the lower jaw side connecting member 4. The attachment surface 60S is a planar surface having a high degree of flatness, besides female screw portions 60a, 60b and recessed portions 60c, 60d to be described below, from which projecting portions have been removed to ensure that the attachment surface 60S contacts the attachment surface 40S of the lower jaw side connecting member 4 perfectly. As shown in FIG. 8C, the two female screw portions 60a, 60b are provided in positions of the attachment surface 60S corresponding to the attachment holes 40a, 40b in the lower jaw side connecting member 4. Hence, by passing the attachment screws 40A, 40B through the attachment holes 40a, 40b and screwing the attachment screws 40A, 40B into the female screw portions 60a, 60b, the lower jaw model 6 is attached to the lower jaw side connecting member 4.

The two recessed portions 60c, 60d are provided in the attachment surface 60S of the lower jaw model 6, and deviation preventing bodies 60C, 60D are provided on respective inner sides of the recessed portions 60c, 60d. The recessed portions 60c, 60d have an equal size to the aforesaid recessed portions 40c, 40d of the lower jaw side connecting member 4, and the deviation preventing bodies 60C, 60D project beyond the attachment surface 60S (see FIG. 9B). More specifically, for easy handling, the deviation preventing bodies 60C, 60D are preferably made of synthetic resin that is injected into the recessed portions 60c, 60d and then hardened. In certain cases, pre-hardened synthetic resin, natural resin, metal, or the like may be fitted into the recessed portions 60c, 60d as the deviation preventing bodies 60C, 60D. As shown in FIG. 9B, when the lower jaw model 6 is attached to the lower jaw side connecting member 4, the deviation preventing bodies 60C, 60D are fitted into the recessed portions 40c, 40d in the lower jaw side connecting member 4, thereby preventing positional deviation.

The articulator 1 described above may be used in a following manner. First, the support member 2 is attached to a base. The support shaft body 20 is then inserted into the support shaft hole 32a in the upper jaw side connecting member 3, whereupon the upper jaw side connecting member 3 and the lower jaw side connecting member 4 are attached in appropriate axial direction positions of the support shaft body 20 by tightening the support shaft fixing screw member 32A. Note that the upper jaw side connecting member 3 and the lower jaw side connecting member 4 are typically handled in a pre-assembled condition, i.e. after connected by the spring members 4A. Further, the upper jaw model 5 and the lower jaw model 6 may be attached either before or after attaching the upper jaw side connecting member 3 and the lower jaw side connecting member 4 to the support shaft body 20.

The upper jaw model 5 is attached by a following procedure. First, the attachment screws 30A, 30B are screwed (loosely screwed) into the female screw portions 50a, 50b in the upper jaw model 5 to a position slightly before a final tightening position. In this condition, an interval between the attachment surface 50S of the upper jaw model 5 and a screw head portion of the attachment screws 30A, 30B is greater than a thickness of the model attachment portion 30 of the upper jaw side connecting member 3. In this condition, the attachment screws 30A, 30B are fitted into the screw insertion grooves 30aa, 30ba, and after the upper jaw model 5 is rotated to such an extent that the attachment screws 30A, 30B reach the attachment holes 30a, 30b, the attachment screws 30A, 30B are tightened sufficiently.

The lower jaw model 6 is attached by a following procedure. First, the attachment screws 40A, 40B are screwed (loosely screwed) into the female screw portions 60a, 60b in the lower jaw model 6 to a position slightly before a final tightening position. In this condition, an interval between the attachment surface 60S of the lower jaw model 6 and a screw head portion of the attachment screws 40A, 40B is greater than a thickness of the model attachment portion 40 of the lower jaw side connecting member 4. In this condition, the attachment screws 40A, 40B are fitted into the screw insertion grooves 40aa, 40ba, and after the lower jaw model 6 is rotated to such an extent that the attachment screws 40A, 40B reach the attachment holes 40a, 40b, the attachment screws 40A, 40B are tightened sufficiently.

Next, a procedure for setting the articulator 1 in the upper/lower jaw open condition will be described. When the upper jaw side connecting member 3 and the lower jaw side connecting member 4 are attached to the support shaft body 20, the lower jaw side connecting member 4 can be rotated freely within a predetermined range (between approximately 20 degrees and 30 degrees, for example), and by the weight of the lower jaw side connecting member 4 (and the lower jaw model 6) itself and by applying slight external force, a condition in which a gap is formed between the upper and lower dentitions 5a, 6a and a condition in which the upper and lower dentitions 5a, 6a contact each other can be established. When external force is applied to rotate the lower jaw side connecting member 4 such that the gap between the upper and lower dentitions 5a, 6a gradually widens, the shaft body insertion portion 43b of the stopper 43 contacts the support shaft body 20 slightly before a predetermined position. When the lower jaw side connecting member 4 is rotated slightly more forcefully from this state, the support shaft body 20 pushes open the shaft body insertion portion 43b so as to be fitted and latched with a click or the like to the hollow portion 43aa of the fitting latch portion 43a in the predetermined position. As a result, the upper/lower jaw open condition can be held, enabling tooth excavation practice using a hand piece and so on.

When, following the excavation practice or the like, the lower jaw side connecting member 4 is rotated quite forcefully in an opposite direction to the fitting and latching direction in order to check the occlusion condition of the teeth, the support shaft body 20 pushes open the shaft body insertion portion 43b such that the fitting latch portion 43a is detached from the support shaft body 20, thereby releasing the hold. When the lower jaw side connecting member 4 is rotated further, the upper and lower dentitions 5a, 6a are occluded, and the occlusion condition can thus be checked.

To replace the upper jaw model 5, the attachment screws 30A, 30B are loosened and the upper jaw model 5 is removed by rotating the upper jaw model 5 in an opposite direction to the attachment direction. The new upper jaw model 5 is then attached in a similar manner to that described above. To replace the lower jaw model 6, the attachment screws 40A, 40B are loosened and the lower jaw model 6 is removed by rotating the lower jaw model 6 in an opposite direction to the attachment direction. The new lower jaw model 6 is then attached in a similar manner to that described above.

Hence, the upper/lower jaw open condition can be held easily by fitting and latching the stopper 43 provided on the lower jaw side connecting member 4 to the support shaft body 20, and the hold can be released easily. Further, the upper jaw model 5 and lower jaw model 6 can be detached and attached easily without adjusting the support shaft body 20, the upper jaw side connecting member 3, and the lower jaw side connecting member 4. As a result, with the articulator 1, a net time spent on the practice of dentistry techniques can be increased, enabling an improvement in the efficiency with which dentistry techniques are practiced.

Further, an operation can be performed with the attachment screws 30A, 30B attached to the upper jaw model 5 and the attachment screws 40A, 40B attached to the lower jaw model 6, and therefore the attachment screws 30A, 30B and the attachment screws 40A, 40B are not misplaced. Furthermore, the screw insertion groove 30aa communicating with the attachment hole 30a and the screw insertion groove 30ba communicating with the other attachment hole 30bb are provided to extend in opposite vertical directions, and the screw insertion groove 40aa communicating with the attachment hole 40a and the screw insertion groove 40ba communicating with the other attachment hole 40b are provided to extend in opposite vertical directions, and therefore, through the attachment operation described above, the upper jaw model 5 and the lower jaw model 6 can be attached easily to the upper jaw side connecting member 3 and the lower jaw side connecting member 4 in appropriately aligned relative positions.

Moreover, the deviation preventing bodies 50C, 50D and the deviation preventing bodies 60C, 60D can prevent positional deviation of the upper jaw model 5 and the lower jaw model 6 relative to the upper jaw side connecting member 3 and the lower jaw side connecting member 4 by absorbing external force applied to the upper jaw model 5 and the lower jaw model 6 during tooth excavation practice using a hand piece or the like. Furthermore, positioning of the upper jaw model 5 and the lower jaw model 6 relative to the upper jaw side connecting member 3 and the lower jaw side connecting member 4 can be performed even more reliably by checking that the deviation preventing bodies 50C, 50D and the deviation preventing bodies 60C, 60D are fitted into the recessed portions 30c, 30d and the recessed portions 40c, 40d during attachment.

Next, an example in which the support member 2 is not attached directly to a base such as a practice treatment table will be described. In this case, a lower end of the support member 2 is separated from a base.

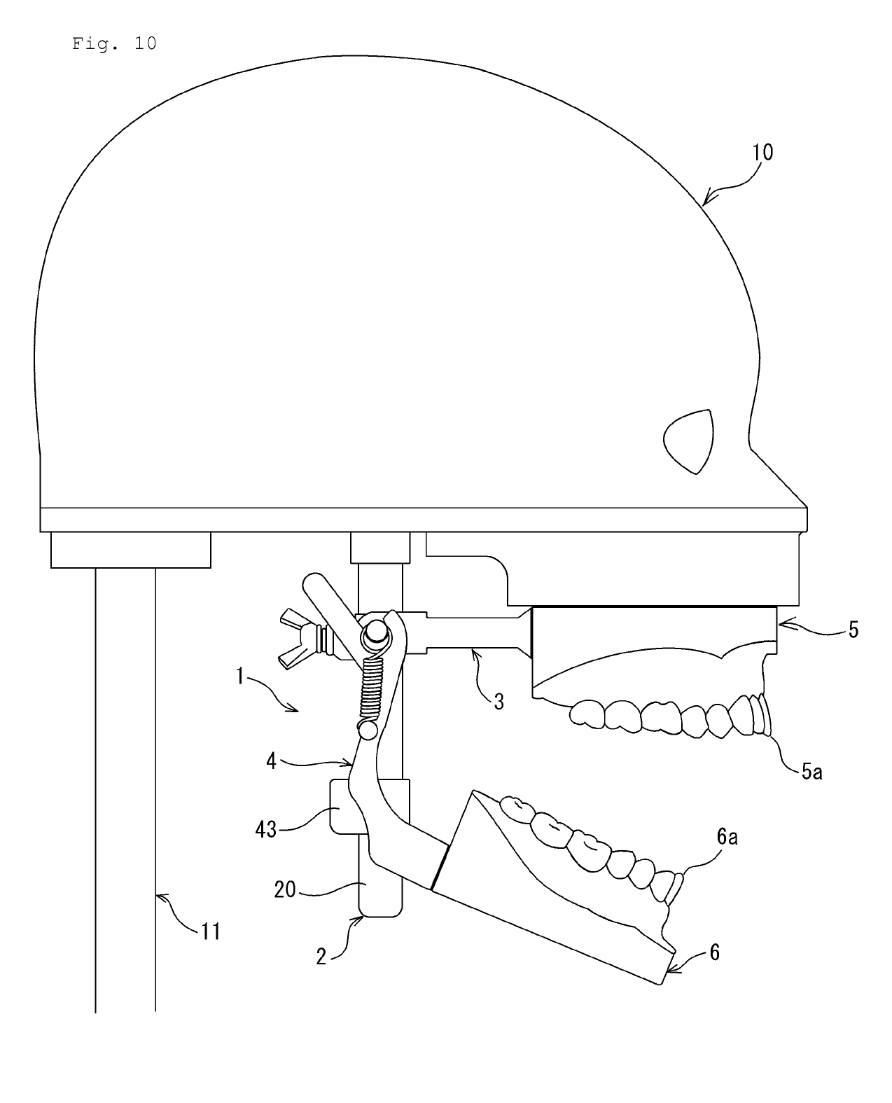

The support member 2 can be attached to a mannequin head 10 that is attached to a base by a base fixing member 11 such as that shown in FIG. 10. In this case, the support shaft body 20 is not limited to a component that extends linearly, and a lower portion of the support shaft body 20 may be bent toward the lower jaw model 6, for example, as shown in FIG. 11. When the support shaft body 20 is bent, an upper/lower jaw open condition in which the gap between the upper and lower dentitions 5a, 6a is not large can be held by fitting and latching the stopper 43 to the support shaft body 20, enabling excavation practice and the like on a person who cannot open his/her mouth wide, such as an elderly person.

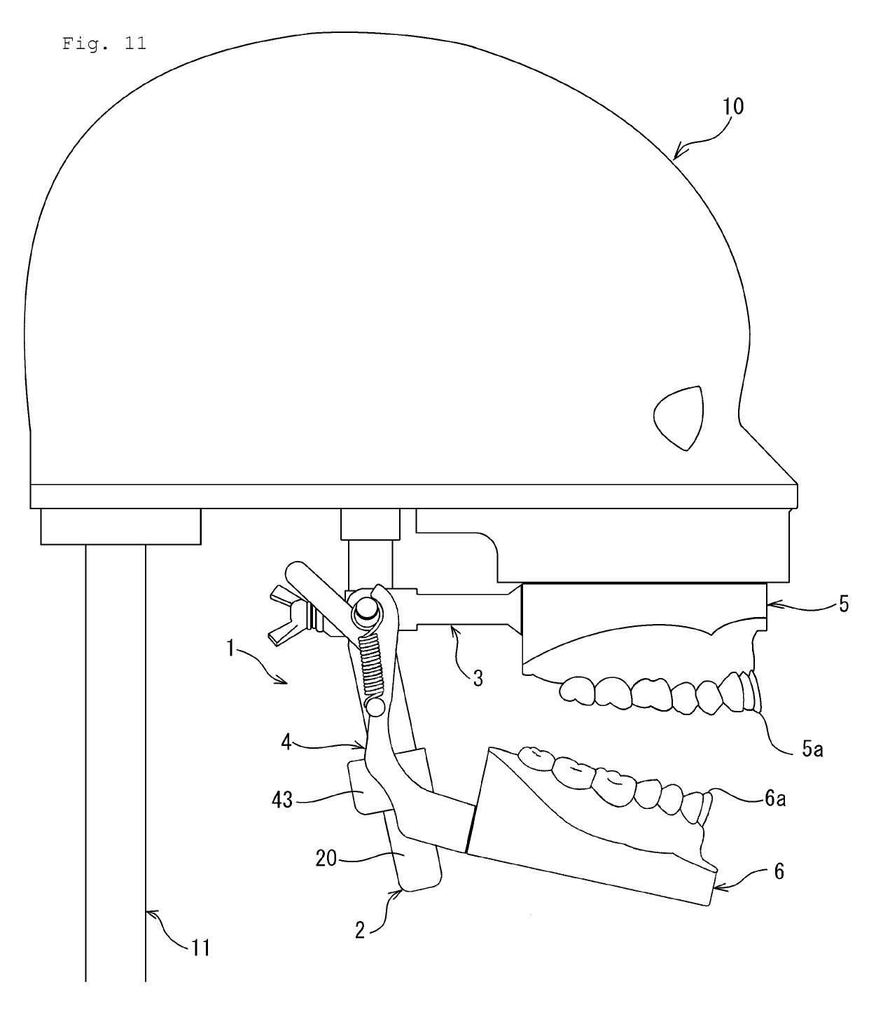

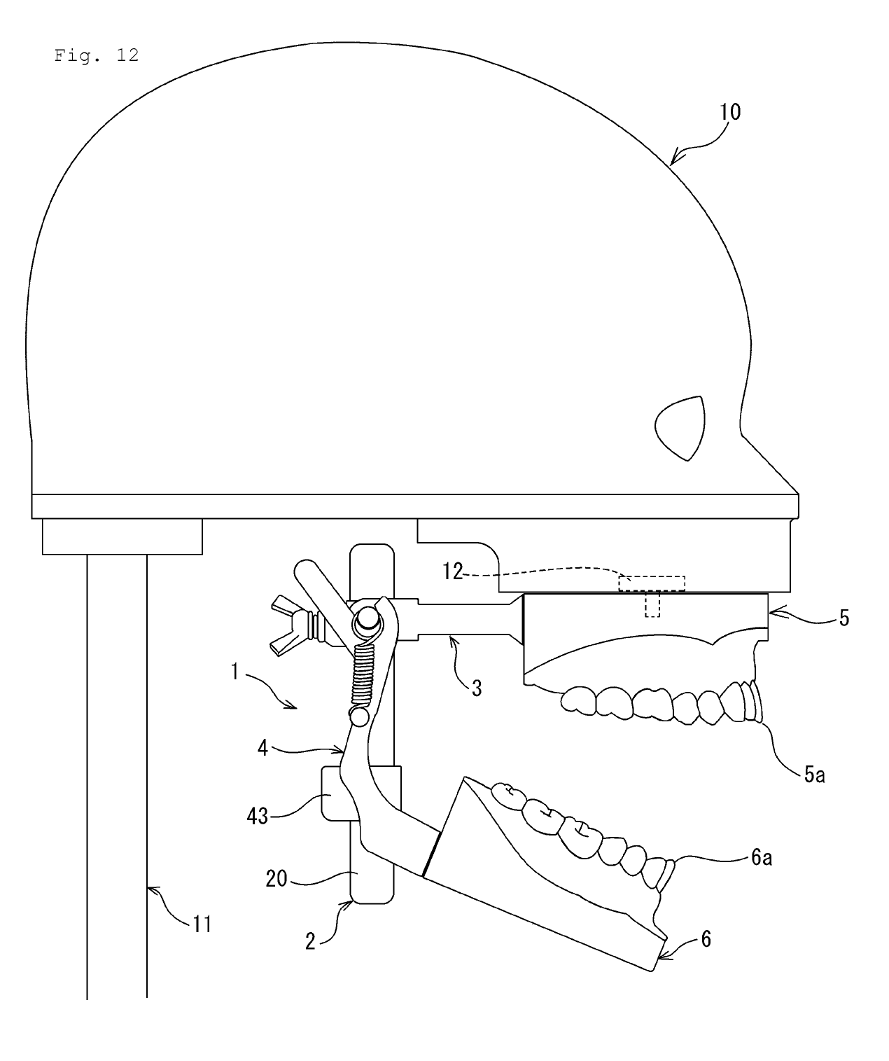

Further, as shown in FIG. 12, the upper jaw model 5 may be attached to the mannequin head 10, which is attached to the base by the base fixing member 11, directly using an upper jaw side fixing tool 12. At this time, the support member 2 is in a separated condition, i.e. not attached directly to the mannequin head 10. As described above, the lower portion of the support shaft body 20 may be bent toward the lower jaw model 6. Furthermore, the upper jaw side connecting member 3 may be attached to the mannequin head 10 by the upper jaw side fixing tool 12 instead of the upper jaw model 5.

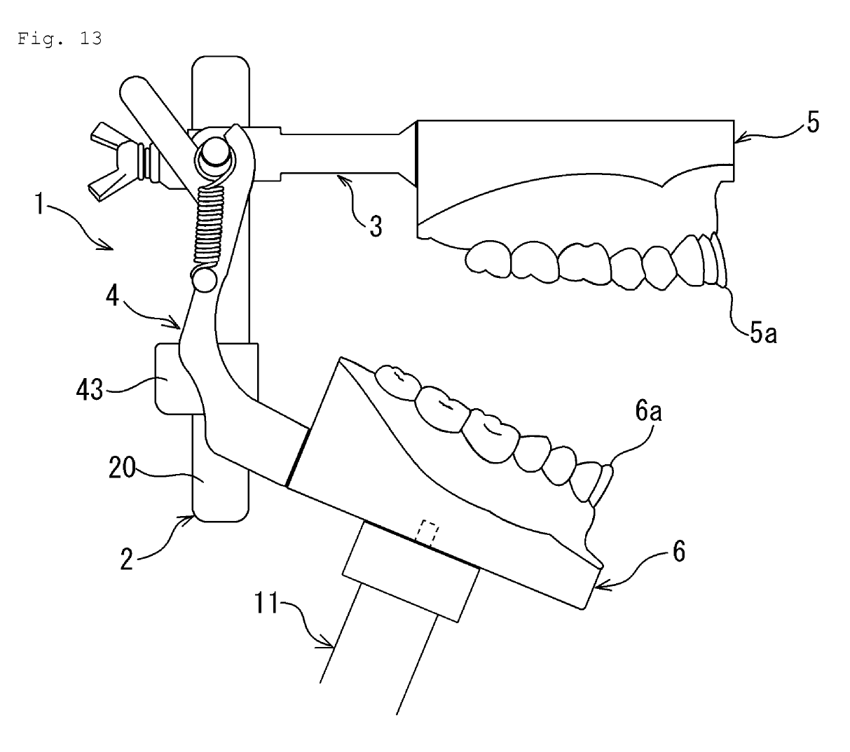

Moreover, in certain cases, as shown in FIG. 13, the lower jaw model 6 may be attached to the base by the base fixing member 11. The lower jaw side connecting member 4 may be attached to the base by the base fixing member 11 instead of the lower jaw model 6. As described above, the lower portion of the support shaft body 20 may be bent toward the lower jaw model 6. The mannequin head 10 may be attached to the support member 2, or may be attached to the upper jaw model 5 or the upper jaw side connecting member 3 by the upper jaw side fixing tool 12.

An articulator according to an embodiment of the present invention was described above, but the present invention is not limited to the above embodiment and may be subjected to various design modifications within the scope of the matter described in the claims. For example, although it is highly preferable in terms of improving the efficiency with which dentistry techniques are practiced that the articulator include the stopper 43 and the model attachment portions 30, 40 described above, in certain cases one of these components may be replaced with a conventional equivalent.

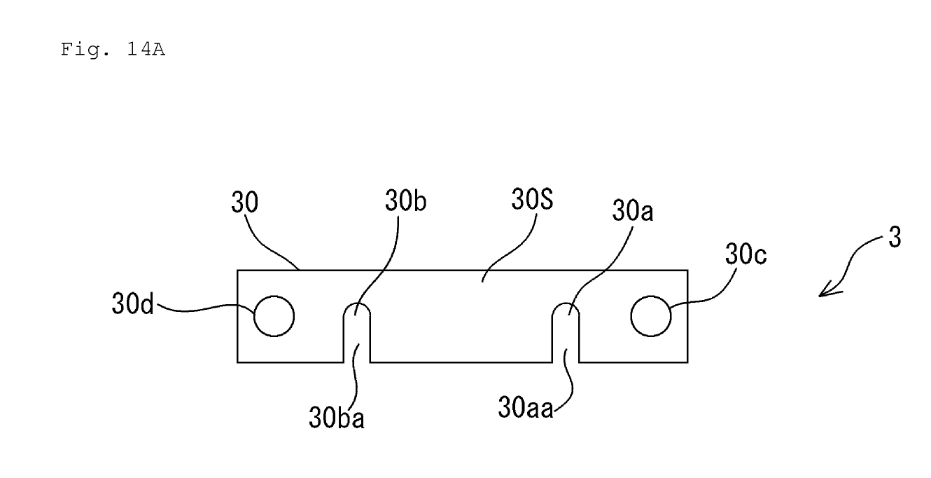

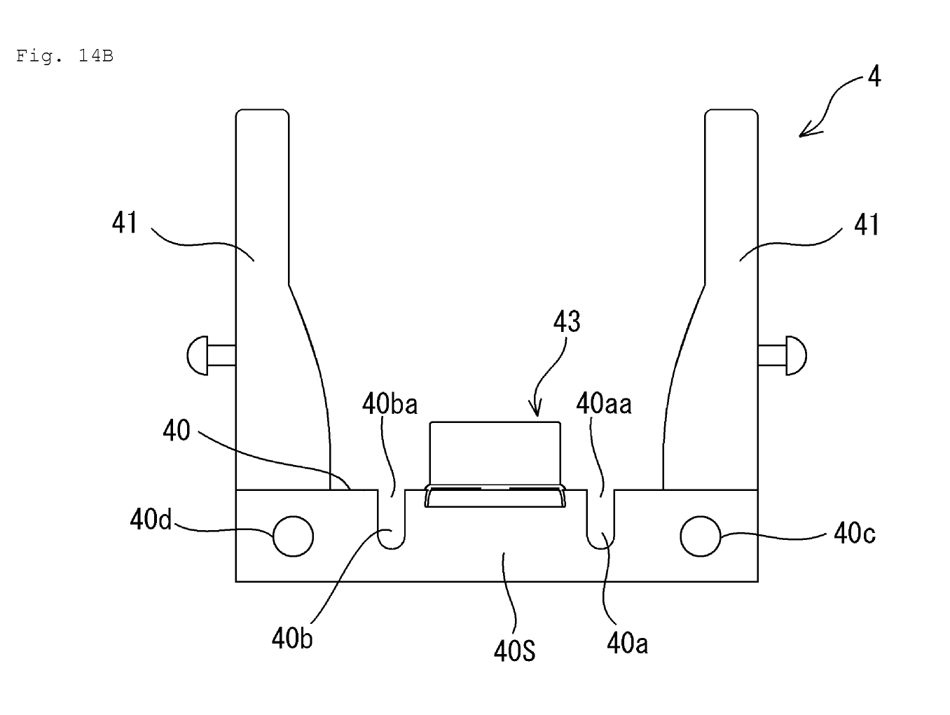

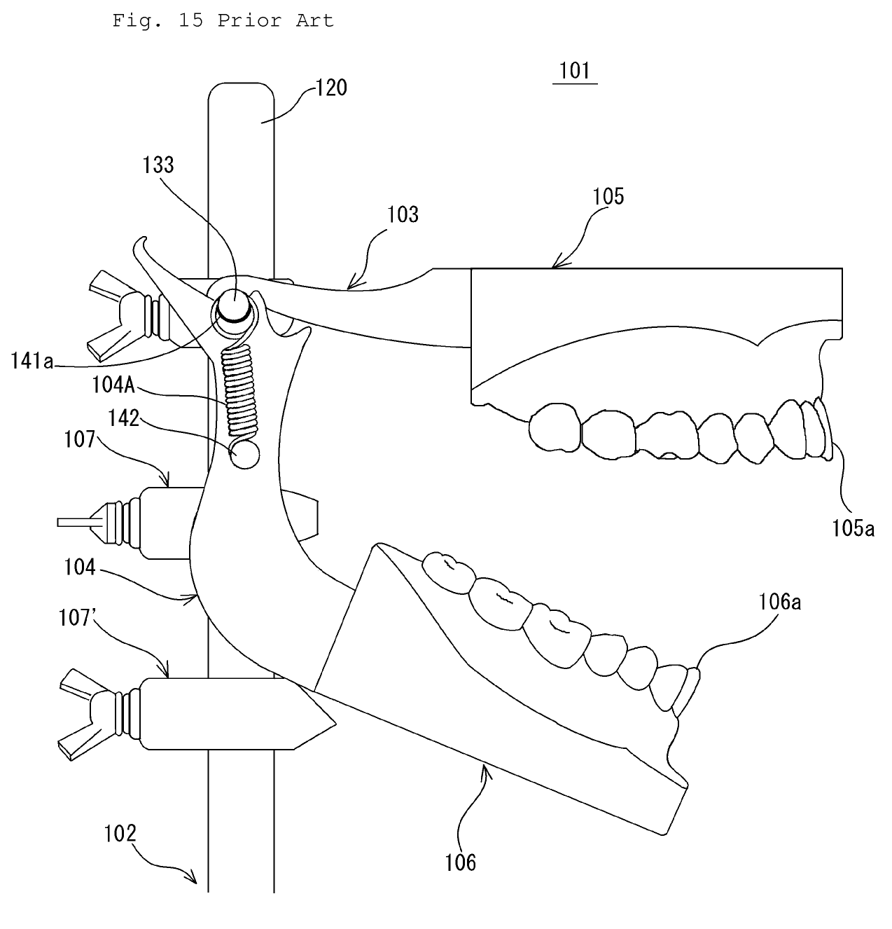

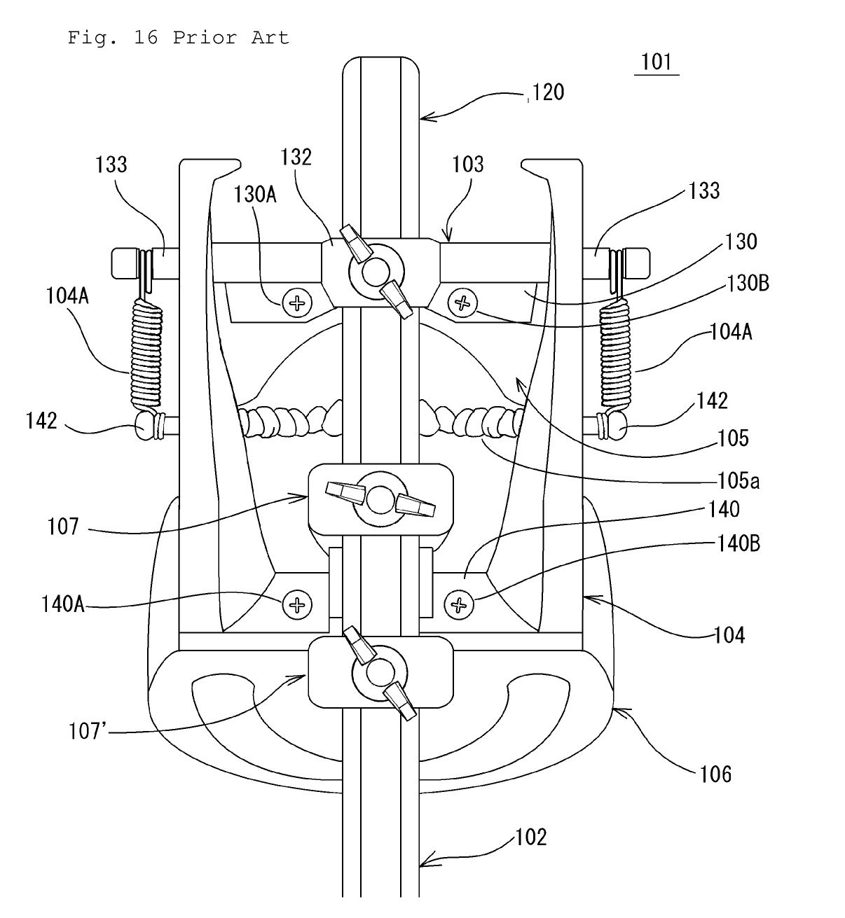

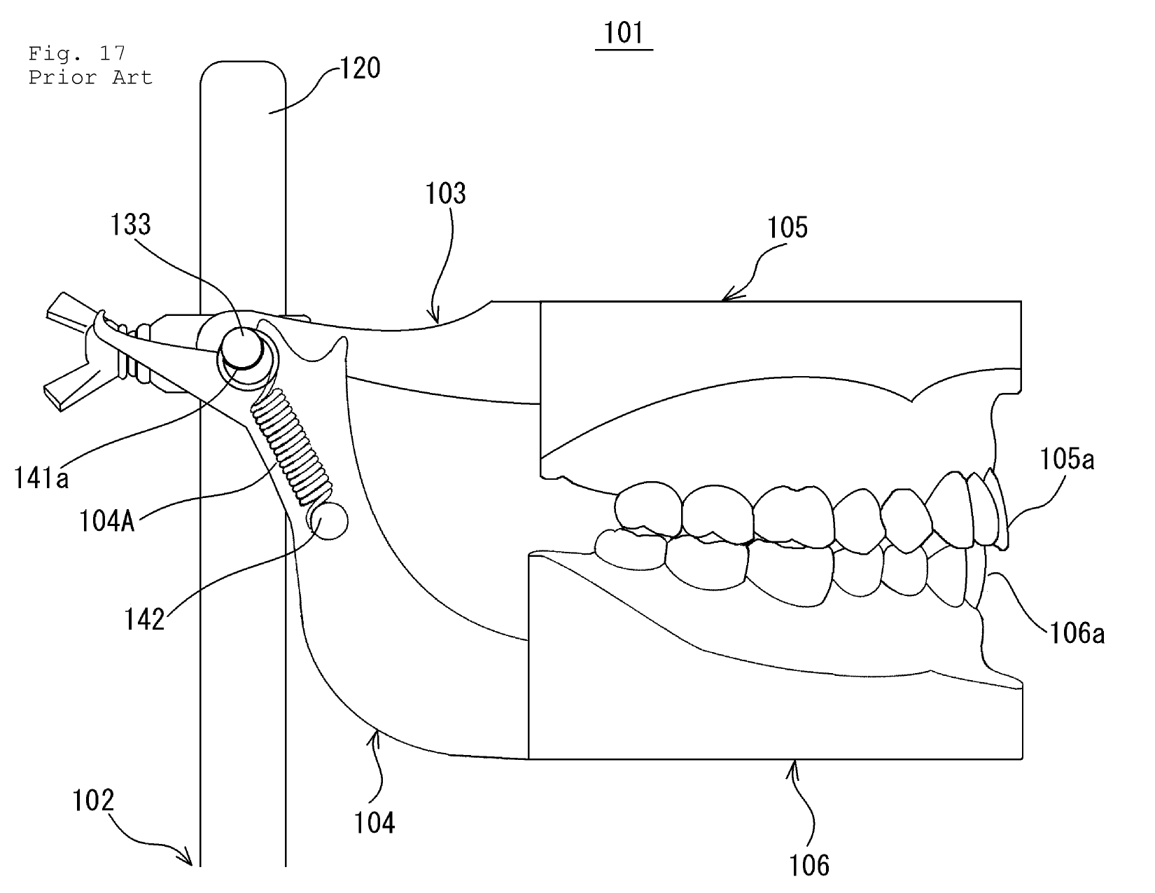

Further, the screw insertion grooves 30aa, 30ba communicating with the attachment holes 30a, 30b in the model attachment portion 30 of the upper jaw side connecting member 3 and the screw insertion grooves 40aa, 40ba communicating with the attachment holes 40a, 40b in the model attachment portion 40 of the lower jaw side connecting member 4 may be deformed. More specifically, as shown in FIG. 14A, the screw insertion grooves 30aa, 30ba may extend either upward or downward (usually downward) in an identical direction from the attachment holes 30a, 30b, and as shown in FIG. 14B, the screw insertion grooves 40aa, 40ba may extend either upward or downward (usually upward) in an identical direction from the attachment holes 40a, 40b. In this case, the positions of the upper jaw model 5 and the lower jaw model 6 relative to the upper jaw side connecting member 3 and the lower jaw side connecting member 4 can be aligned appropriately by tightening the attachment screws 30A, 30B after fitting the deviation preventing bodies 50C, 50D of the upper jaw model 5 into the recessed portions 30c, 30d in the upper jaw side connecting member 3 and tightening the attachment screws 40A, 40B after fitting the deviation preventing bodies 60C, 60D of the lower jaw model 6 into the recessed portions 40c, 40d in the lower jaw side connecting member 4.

Furthermore, in certain cases, only one of the upper jaw side connecting member 3 and the lower jaw side connecting member 4 may be formed with the configuration on the periphery of the attachment holes described above such that only one of the upper jaw model 5 and the lower jaw model 6 is attached and detached using the method described above. More specifically, regardless of the configuration on the periphery of the attachment holes 40a, 40b in the lower jaw side connecting member 4, the upper jaw side connecting member 3 may be formed such that the screw insertion groove 30aa extending diagonally upward or downward communicates with one of the attachment holes 30a and the screw insertion groove 30ba extending diagonally downward or upward communicates with the other attachment hole 30b (i.e. configured as illustrated in FIG. 6A), or such that the screw insertion grooves 30aa, 30ba extending either upward or downward in an identical direction communicate with the attachment holes 30a, 30b (i.e. configured as illustrated in FIG. 14A). In this case, the attachment holes 40a, 40b in the lower jaw side connecting member 4 may have a conventional configuration not provided with the screw insertion grooves 40aa, 40ba. Alternatively, regardless of the configuration on the periphery of the attachment holes 30a, 30b in the upper jaw side connecting member 3, the lower jaw side connecting member 4 may be formed such that the screw insertion groove 40aa extending diagonally upward or downward communicates with one of the attachment holes 40a and the screw insertion groove 40ba extending diagonally downward or upward communicates with the other attachment hole 40b (i.e. configured as illustrated in FIGS. 8A and 8B), or such that the screw insertion grooves 40aa, 40ba extending either upward or downward in an identical direction communicate with the attachment holes 40a, 40b (i.e. configured as illustrated in FIG. 14B). In this case, the attachment holes 30a, 30b in the upper jaw side connecting member 3 may have a conventional configuration not provided with the screw insertion grooves 30aa, 30ba.

What is claimed is:

1. An articulator comprising:
a support member having a rod-shaped support shaft body;
an upper jaw side connecting member attached to said support shaft body in an appropriate axial direction position;
a lower jaw side connecting member connected rotatably to said upper jaw side connecting member;
an upper jaw model attached so as to contact an attachment surface of a model attachment portion of said upper jaw side connecting member; and
a lower jaw model attached so as to contact an attachment surface of a model attachment portion of said lower jaw side connecting member,
wherein said lower jaw side connecting member has a stopper that includes a penetrating hollow portion and is fitted and latched to said support shaft body when rotated to a predetermined position.

2. The articulator according to claim 1, wherein said stopper is made of synthetic resin.

3. The articulator according to claim 1, wherein said hollow portion of said stopper penetrates in an inclined direction relative to said attachment surface of said model attachment portion of said lower jaw side connecting member.

4. The articulator according to claim 1, wherein back surface side recessions are formed in said lower jaw side connecting member at a left position and a right position of said stopper.

5. The articulator according to claim 1, wherein
two attachment holes are provided in said respective model attachment portions of said upper jaw side connecting member and said lower jaw side connecting member,
two female screw portions are provided in positions of said upper jaw model corresponding to said attachment holes in said model attachment portion of said upper jaw side connecting member,
two female screw portions are provided in positions of said lower jaw model corresponding to said attachment holes in said model attachment portion of said lower jaw side connecting member, and
said upper jaw model is attached to said upper jaw side connecting member and said lower jaw model is attached to said lower jaw side connecting member by respective attachment screws that are passed through said attachment holes and screwed into said female screw portions.

6. The articulator according to claim 5, wherein a screw insertion groove extending diagonally upward or downward so as to communicate with one of said attachment holes and a screw insertion groove extending diagonally downward or upward so as to communicate with another of said attachment holes are provided in said upper jaw side connecting member.

7. The articulator according to claim 5, wherein screw insertion grooves extending either upward or downward in an identical direction so as to communicate with said two attachment holes are provided in said upper jaw side connecting member.

8. The articulator according to claim 6, wherein two recessed portions are provided in an attachment surface of said upper jaw side connecting member that is contacted by said upper jaw model,
two recessed portions are provided in an attachment surface of said upper jaw model that contacts said upper jaw side connecting member, and
deviation preventing bodies are provided on respective inner sides of said recessed portions of said upper jaw model.

9. The articulator according to claim 7, wherein two recessed portions are provided in an attachment surface of said upper jaw side connecting member that is contacted by said upper jaw model,
two recessed portions are provided in an attachment surface of said upper jaw model that contacts said upper jaw side connecting member, and
deviation preventing bodies are provided on respective inner sides of said recessed portions of said upper jaw model.

10. The articulator according to claim 5, wherein a screw insertion groove extending diagonally upward or downward so as to communicate with one of said attachment holes and a screw insertion groove extending diagonally downward or upward so as to communicate with another of said attachment holes are provided in said lower jaw side connecting member.

11. The articulator according to claim 5, wherein screw insertion grooves extending either upward or downward in an identical direction so as to communicate with said two attachment holes are provided in said lower jaw side connecting member.

12. The articulator according to claim 10, wherein
two recessed portions are provided in an attachment surface of said lower jaw side connecting member that is contacted by said lower jaw model,
two recessed portions are provided in an attachment surface of said lower jaw model that contacts said lower jaw side connecting member, and
deviation preventing bodies are provided on respective inner sides of said recessed portions of said lower jaw model.

13. The articulator according to claim 11, wherein
two recessed portions are provided in an attachment surface of said lower jaw side connecting member that is contacted by said lower jaw model,
two recessed portions are provided in an attachment surface of said lower jaw model that contacts said lower jaw side connecting member, and
deviation preventing bodies are provided on respective inner sides of said recessed portions of said lower jaw model.

14. The articulator according to claim 1, wherein
said support member is attached to a base by a base attachment portion.

15. The articulator according to claim 1, wherein
said support member is attached to a mannequin head that is attached to a base by a base fixing member.

16. The articulator according to claim 1, wherein
said upper jaw model or said upper jaw side connecting member is attached to a mannequin head that is attached to a base by a base fixing member.

17. The articulator according to claim 1, wherein
said lower jaw model or said lower jaw side connecting member is attached to a base by a base fixing member.

18. The articulator according to claim 15, wherein a lower portion of said support shaft body of said support member is bent toward said lower jaw side connecting member.

19. The articulator according to claim 16, wherein a lower portion of said support shaft body of said support member is bent toward said lower jaw side connecting member.

20. The articulator according to claim 17, wherein a lower portion of said support shaft body of said support member is bent toward said lower jaw side connecting member.
